(19) United States
(12) Patent Application Publication
(10) Pub. No.: US 2012/0082748 A1
(43) Pub. Date: Apr. 5, 2012

(54) SIMULTANEOUSLY-INFLATED PLASTIC BLOW MOLD

(76) Inventor: Chien-Li CHEN, Tainan City (TW)

(21) Appl. No.: 13/252,800

(22) Filed: Oct. 4, 2011

(30) Foreign Application Priority Data
Oct. 5, 2010 (TW) 99219239

(51) Int. Cl. B29C 49/30

(52) U.S. Cl. 425/536

(57) ABSTRACT

A simultaneously-inflated plastic blow mold includes a left mold and a right mold. The left mold or the right mold fixedly disposed with a control device includes a mold trough formed with a guide hole therein. When the left and right molds are closed, a gas nozzle is moved in the plastic blow mold to blow a product. The gas nozzle is stopped blowing the gas and withdrew from the plastic blow mold when the mold closing is completed. The control device is utilized to adjust a gas needle to enter the inside of the plastic blow mold via an inflating seat and to penetrate through the valve nozzle on a plastic blow product. The control device can adjust the gas blowing or exhausting step inside the hollow portion of the plastic blow product to remain a stable gas flow in the product blowing step.

### BACKGROUND OF THE INVENTION

1. Field of the Invention

The present invention relates to a simultaneously-inflated plastic blow mold providing a mold trough formed with a guide hole therein and a control device, and a gas needle disposed in and controlled by the fixedly-disposed control device is utilized to perform the gas blowing or exhausting step inside the hollow portion of a plastic blow product.

2. Description of the Related Art

Plastic product molding processes such as injection molding or blow molding process shall be performed by molds. Conventional bottles, jars or ball products, particular to plastic products (e.g. balls) made of soft materials, are often formed by the blow molding process. In general, for the blow molded products without a valve nozzle thereon, these blow molded products actually cannot be inflated or exhausted in the blow molding process or after mold opening.

Generally, high frequency heating methods and centrifugal-forced molding methods in a rotary furnace are utilized to form a valve nozzle on an inflatable blow molded product. In the high frequency heating method, the blow molded product and the valve nozzle combined with a cloth layer are integrally formed by high-frequency heating, and then the unnecessary part(s) of the cloth layer must be cut away after the high-frequency heating process is completed.

However, the conventional blowing steps still have inconveniences and difficulties as follows.

Firstly, for the blow molded products without a valve nozzle thereon, because the gas flow rate cannot be steadily controlled in the blowing step and without the installation of the valve nozzle, it is difficult to control the sizes of the blow molded products, such as too large or small in size.

Secondly, the high frequency heating method using to form the blow molded product with the valve nozzle has a complicated operation steps and high manufacturing cost, incapable of satisfying economic utility and decreasing the product competitiveness in the market.

Thirdly, it is advantageous that the blow molded product and the valve nozzle can be integrally formed by the centrifugal-forced molding method in the rotary furnace. However, the operation of the rotary furnace is limited to the products such as molded emulsion products, PVC products characterized with fluidity and low viscosity, and similar symmetrical products (e.g., emulsion balls). That is, thermoplastic elastomers (TVR) (e.g. PE and TPE), products characterized with low fluidity and high viscosity, and asymmetrical products are not allowed to be used in the rotary furnace.

In view of the deficiencies in the conventional blow molds, the inventor who specializes in manufacturing and vending plastic products provides an improved simultaneously-inflated plastic blow mold of the present invention to overcome the conventional difficulties, based on his data collection in different fields, trials and errors, and the working experiences for years.

### BRIEF SUMMARY OF THE INVENTION

The present invention is related to a simultaneously-inflated plastic blow mold, mainly being composed of a left mold and a right mold. The present invention differs from the conventional blow mold in that the left mold (or the right mold) fixedly disposed with an inflating seat includes a mold trough formed with a guide hole therein. The inflating seat includes a sleeve post formed with a through hole. The sleeve post of the inflating seat includes one end protruded in the mold trough of the left mold and the other end outwardly protruded from the mold trough of the left mold to connect to the control device. A gas needle disposed in the control device is retractably controlled by the gas pressure. A valve nozzle is jacketed on the protruded sleeve post disposed in the mold trough of the left mold before the operation process. Material is fed between the left mold and the right mold, and the gas nozzle is moved in the plastic blow mold to slowly blow a product until the left mold and the right mold are closed. Then, the gas nozzle is stopped blowing the gas and withdrew from the plastic blow mold when the mold closing is completed. The control device is utilized to adjust the gas needle to enter the inside of the plastic blow mold via the inflating seat and to penetrate through the valve nozzle disposed on a plastic blow product (e.g., balls) in the plastic blow mold. In the product blowing step, the control device can adjust the gas blowing or exhausting step inside the hollow portion of the plastic blow product and remain the stability of the gas flow in the product blowing step. When the product blowing step is completed, the valve nozzle and the plastic blow product are integrally formed. It is obvious that the present invention have inventive step to rapidly and conveniently simply the manufacturing process and reduce the manufacturing cost.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is an outside perspective view of a plastic blow mold of the present invention;

FIG. 2 is a perspective view of a left mold of the present invention;

FIG. 3 is a side sectional view of the plastic blow mold of the present invention;

FIG. 4 is a schematic view of a working status of the plastic blow mold of the resent invention;

FIG. 5 is a partial sectional view of the plastic blow mold of the present invention, wherein the plastic blow mold is operated in an inflation step; and

FIG. 6 is a partial sectional view of the plastic blow mold of the present invention, wherein the inflation step of the plastic blow mold is completed.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

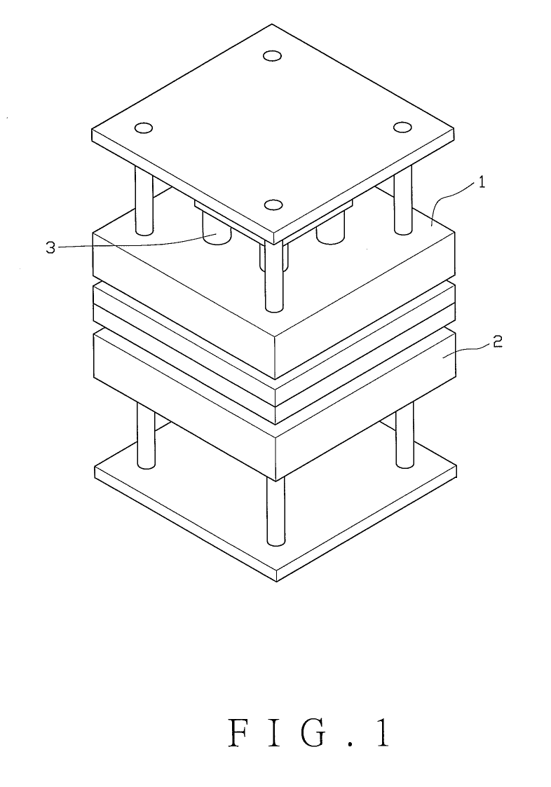

FIG. 1 is an outside perspective view of a plastic blow mold of the present invention. The plastic blow mold is mainly composed of a left mold 1 and a right mold 2 (vertically disposed in FIG. 1). The structure of the left mold 1 and the right mold 2 of the plastic blow mold differs from the conventional mold structure in that the left mold 1 (or the right mold 2) is provided with a control device 3 utilized to adjust an inflating step of a plastic blow product in the plastic blow mold, thereby providing a plastic blow molding process to perform the inflating step and simplifying the steps of the plastic blow molding process.

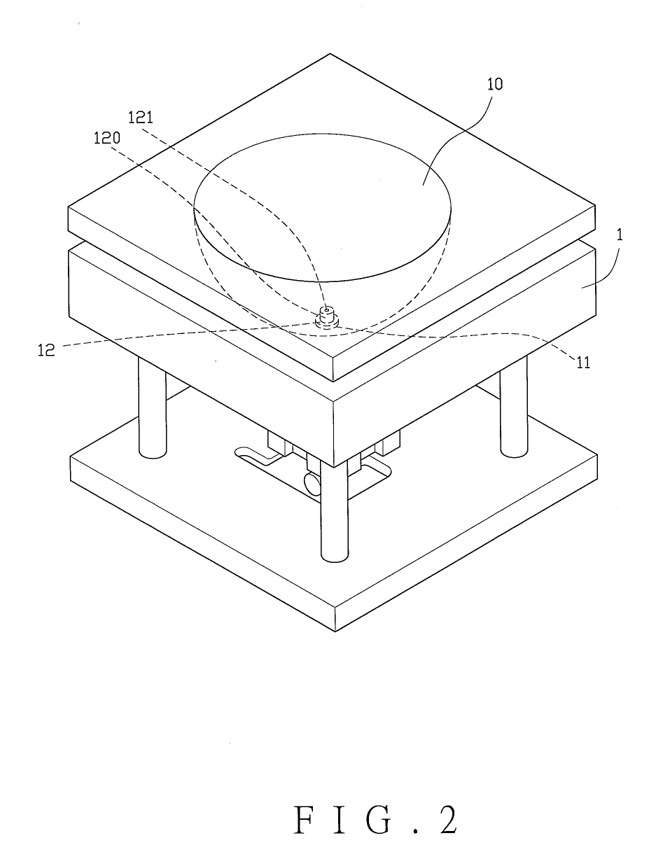

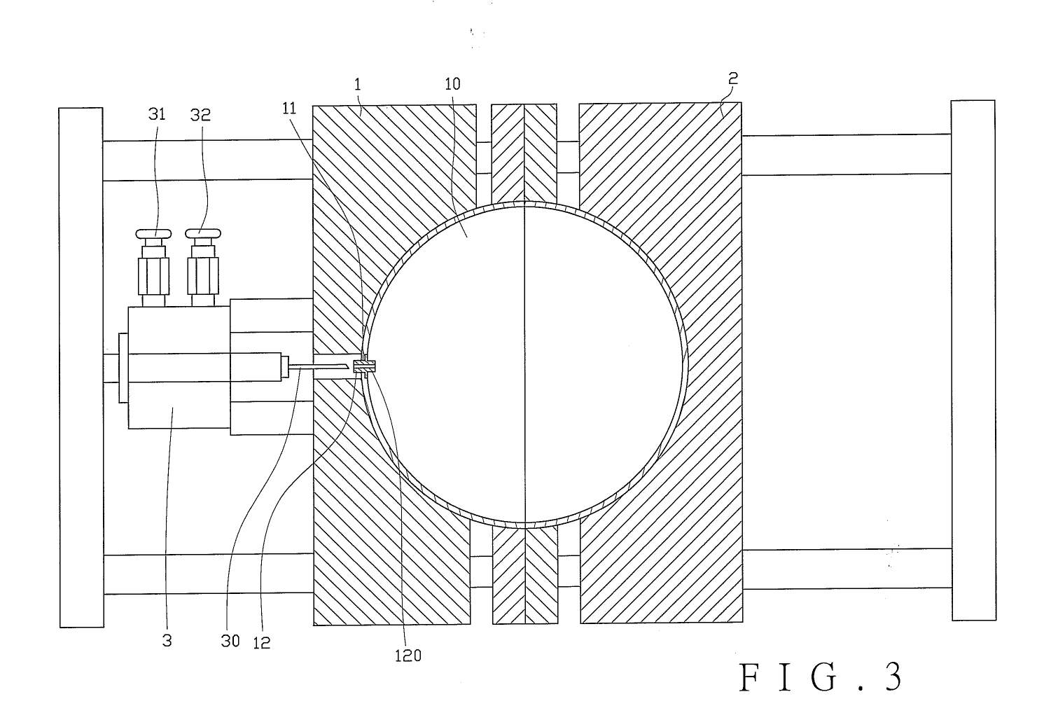

FIG. 2 is a perspective view of the left mold 1 of the present invention. The left mold 1 (or the right mold 2) comprises a mold trough 10 formed with a guide hole 11 and an inflating seat 12 including a sleeve post 120 formed with a through hole 121, wherein the guide hole 11 of the mold trough 10 is fixedly installed with the inflating seat 12. In FIG. 2, the mold trough 10 of the left mold 1 is a spherical mold. Referring also to FIG. 3, FIG. 3 is a side sectional view of the plastic blow mold of the present invention. The sleeve post 120 of the inflating seat 12 includes a first end protruded in the mold trough 10 of the left mold 1 and a second end outwardly protruded from the mold trough 10 of the left mold 1 to connect to the control device 3 (not shown in Figs.).

FIG. 3 is a side sectional view of the plastic blow mold of the present invention. The left mold 1 (or the right mold 2) comprises the mold trough 10 formed with the guide hole 11 and connected with the inflating seat 12. The sleeve post 120 of the inflating seat 12 includes one end protruded in the mold trough 10 of the left mold 1 and the other end outwardly protruded from the mold trough 10 of the left mold 1 to connect to the control device 3. In FIG. 3, a gas needle 30 is provided in the control device 3, and an inlet 31 and an outlet 32 are disposed outside of the control device 3, so that the gas pressure can be utilized to adjust the gas needle 30 through the inlet 31 and the outlet 32 of the control device 3. Further, the inlet 31 and the outlet 32 of the control device 3 are communicated to a pneumatic device of a plastic blow molding machine (not shown in Figs.). The gas needle 30 disposed in the control device 3 is adjustably entered into the sleeve post 120 of the inflating seat 12 when a gas is input into the control device 3 through the inlet 31, and the gas needle 30 is retracted form the inflating seat 12 to return in the control device 3 when the gas is input into the control device 3 through the outlet 32.

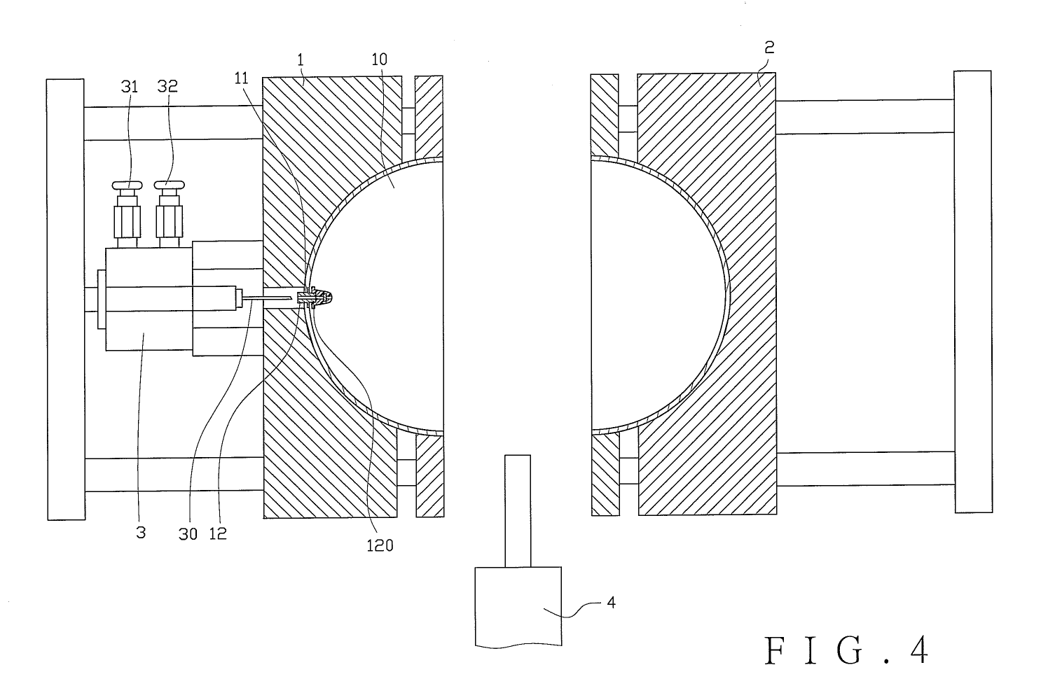

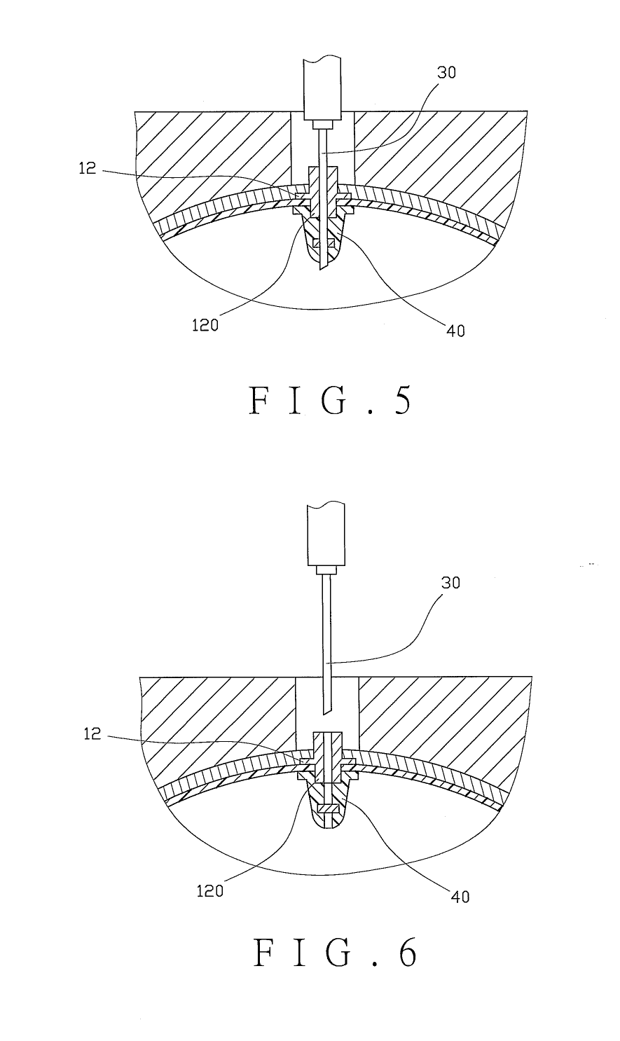

Referring to FIG. 4 and FIG. 5, in the operation process, a valve nozzle 4 0 is jacketed on the protruded sleeve post 120 disposed in the mold trough 10 of the left mold 1. A machine feeds a plastic material into the plastic blow mold via a feeding channel thereof (not shown in drawings), and a gas nozzle 4 is moved between the left mold 1 and the right mold 2 to slowly blow the gas into the plastic blow mold when the left mold 1 and the right mold 2 are closed. Then, the gas nozzle 4 is stopped blowing the gas and withdrew from the plastic blow mold when the mold closing is completed. Then, the control device 3 is actuated by inputting the gas through the inlet 31, and the gas needle 30 is adjusted to enter the inflating seat 12 via the through hole 121 of the sleeve post 120 and to penetrate through the valve nozzle 40 disposed on a plastic blow product, so that the gas can be injected into the hollow portion of the plastic blow product by the gas needle 30 passed through the valve nozzle 40 to perform a gas blowing or exhausting step, thereby forming the valve nozzle 40 and the plastic blow product into an integral piece.

With respect to the inflation step of the present invention, please refer to FIGS. 4 and 5 simultaneously. When the valve nozzle 40 is disposed in the left mold 1 for performing the blow molding process, the gas is input into the control device 3 through the inlet 31 thereof to adjust the gas needle 30 to enter into the inflating seat 12 via the through hole 121 of the sleeve post 120, so that the gas needle 30 penetrates through the valve nozzle 40 to enter into the hollow portion of the plastic blow product to perform the gas blowing process. When the inflating step of the plastic blow molding process is completed, the control device 3 is automatically controlled to input the gas into the outlet 32 thereof to adjust the gas needle 30 to return into the control device 3 from the valve nozzle 40 (shown in FIG. 6), and the valve nozzle 40 is closed to prevent the injected gas from leakage. The valve nozzle 40 is designed with a conventional soft valve for performing the closing function, and herein the detailed description of the valve nozzle 40 is omitted.

With the improved simultaneously-inflated plastic blow mold of the present invention to form the valve nozzle 40 and the plastic blow product into an integral piece, it is noted that the present invention provides with the advantages as follows.

Firstly, the soft plastic blow molding process and the inflation step in the hollow portion of a plastic blow product can be simultaneously performed, so that the improved simultaneously-inflated plastic blow mold of the present invention has inventive step and the secondary processing can be eliminated.

Secondly, the plastic blow product and the valve nozzle can be integrally formed by utilizing the control device 3 to adjust the gas needle 30 to perform the gas blowing or exhausting step; thereby simplifying the manufacturing process to reduce the cost, and satisfying economic utility and increasing the product competitiveness in the market.

Thirdly, after the gas nozzle 4 performs the gas blowing step, the control device 3 still can adjust the gas needle 30 to perform the gas blowing or exhausting step to the hollow portion of the plastic blow product and to stably inflate the plastic blow product. Thus, with the improved simultaneously-inflated plastic blow mold of the present invention, the secondary processing can be eliminated, the _{—} productivity can be increased, and the manpower can be reduced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A simultaneously-inflated plastic blow mold, comprising a left mold and a right mold capable of providing a blow molding process, characterized in that the left mold comprises a mold trough formed with a guide hole utilized to be fixedly installed with an inflating seat including a sleeve post formed with a through hole, the sleeve post of the inflating seat includes a first end protruded in the mold trough of the left mold and a second end outwardly protruded from the mold trough of the left mold to connect to a control device, a gas needle disposed in the control device is adjusted by gas pressure to be retractable in the inflating seat, and the right mold and the left mold are closed to be provided for the blow molding process.

2. The simultaneously-inflated plastic blow mold as claimed in claim 1, wherein the right mold includes a mold trough, and the inflating seat is selectively disposed in the mold trough of the right mold.

3. The simultaneously-inflated plastic blow mold as claimed in claim 1, wherein the control device includes an inlet and an outlet which are utilized to adjust the gas needle by the gas pressure.

4. The simultaneously-inflated plastic blow mold as claimed in claim 1, wherein the gas needle penetrates through and into a hollow portion of a plastic blow product to perform an gas blowing or exhausting step when the gas needle is retractably moved.
